(19) United States
(12) Patent Application Publication
(10) Pub. No.: US 2005/0117078 A1
(43) Pub. Date: Jun. 2, 2005

(54) Storage capacitor for liquid crystal display

(76) Inventors: Chien-Ting Lai, Miao-Li (TW); Jia-Pang Pang, Miao-Li (TW); Yung-Chang Chen, Miao-Li (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/994,757

(22) Filed: Nov. 22, 2004

(30) Foreign Application Priority Data
Nov. 29, 2003 (CN) 2003101124395

(51) Int. Cl. G02F 1/1343

(52) U.S. Cl. 349/38

(57) ABSTRACT

A storage capacitor in a liquid crystal display is provided for increasing the capacitance of the storage capacitor without substantially changing the manufacturing process, the storage capacitor including a first capacitor electrode (18), a first insulating layer (16) formed on the first capacitor electrode, a second capacitor electrode (14) formed on the first insulating layer, a second insulating layer (12) formed on the second capacitor electrode, and a third capacitor electrode (11) formed on the second insulating layer and electrically connected with the first capacitor electrode. The second capacitor electrode is electrically connected with the pixel electrode (10) of the liquid crystal display. With this configuration, the capacitance of the storage capacitor is substantially increased without reducing the aperture ratio of each pixel of a liquid crystal display.

### BACKGROUND OF THE INVENTION

1. Field of the Invention

The present invention relates generally to liquid crystal displays (LCD), and more particularly to a storage capacitor in an LCD.

2. Prior Art

These days, liquid crystal displays are gradually replacing the cathode ray tube (CRT) displays traditionally used for computers. Further, liquid crystal displays are thin and compact, making them very suitable not only for desktop computers, but also for numerous other electronic products. Such electronic products include laptop computers, personal digital assistants (PDAs), cellular phones, televisions, and many other kinds of office automation (OA) and audiovisual (AV) equipment.

A liquid crystal display employs an active matrix array comprising: a plurality of pixel regions, each having a pixel electrode; gate and source lines crossing each other to define the pixel regions; and a plurality of thin film transistors (TFTs) located adjacent the crossings of the gate and source lines for switching on and off the pixel electrodes.

When a signal is sent to switch on the TFTs, the pixel regions of a liquid crystal display are enabled. In order to achieve high picture quality for a liquid crystal display, the voltage on the pixel electrodes must be maintained at a constant value until the next signal is received. However, the electric charges for maintaining the voltage on the pixel electrodes leak away in a very short time, thus decreasing the display quality of the liquid crystal display. For this reason, a storage capacitor is needed in each pixel of a liquid crystal display, for maintaining the voltage on the pixel electrode.

FIG. 4 shows a conventional pixel region 2 of a liquid crystal display. The pixel region 2 comprises a pixel electrode 20, source lines 23, gate lines 28, a thin film transistor (TFT) region, and a storage capacitor (SC) region. As shown, the source lines 23 and the gate lines 28 cross each other, thereby defining the pixel region 2. A portion of the pixel electrode 20 is electrically connected with the source line 23 via the thin film transistor, the thin film transistor (TFT) acting as a switch for turning on and off the pixel electrode 20. Another portion of the pixel electrode 20 is electrically connected with the gate line 23 via the storage capacitor (SC).

FIG. 5 is a cross-sectional view of the storage capacitor, taken along line V-V of FIG. 4. The storage capacitor is formed on a glass substrate 29, and comprises a first capacitor electrode 28, a first insulating layer 26, a second capacitor electrode 24, a second insulating layer 22 and a pixel electrode 20. The first capacitor electrode 28 is the gate line made of conductive materials such as aluminum, aluminum alloy, tantalum, or chrome. The first insulating layer 26 is formed covering the first capacitor electrode 28 and the glass substrate 29, and is preferably made of silicon nitride (SiNx). The second capacitor electrode 24 is formed on the first insulating layer 26 above the first capacitor electrode 28, and is preferably made of conductive materials such as aluminum, aluminum alloy, tantalum or chrome. The second insulating layer 22 is formed covering the second capacitor electrode 24 and the first insulating layer 26, and is preferably made of silicon nitride (SiNx). A hole is formed in the second insulating layer 22 at the region above the center portion of the second capacitor electrode 24, for exposing the center portion of the second capacitor electrode 24. Finally, the pixel electrode 20, which is preferably made of indium tin oxide (ITO), is formed on the second insulating layer 22 with an extending portion penetrating through the hole formed in the second insulating layer 22 and electrically connecting with the second capacitor electrode 24. The storage capacitor is thus defined.

Since the storage capacitor described above is equivalent to a capacitor with two parallel planes, the capacitance formula

$${C}_{ST} = \frac{ɛ \cdot A}{d}$$

is applicable, where “C_{ST}” denotes the storage capacitance, “ε” denotes the dielectric constant of the first insulating layer 26 between the first capacitor electrode 28 and the second capacitor electrode 24, “A” denotes the effective area of the first capacitor electrode 28 and the second capacitor electrode 24, and “d” denotes the thickness of the first insulating layer 26 between the first capacitor electrode 28 and the second insulating layer 24. Therefore, the capacitance of the storage capacitor is proportional to the effective area “A,” and inversely proportional to the thickness “d.”

For a constant thickness “d ,” the only way to increase the capacitance of the storage capacitor is to increase the effective area “A.” However, if the effective area “A” is increased, the aperture ratio of the pixel region 2 is reduced. This severely limits the display quality of the liquid crystal display. Therefore, a new storage capacitor is needed to overcome the above-described shortcomings.

### SUMMARY OF THE INVENTION

An objective of the present invention is to provide a storage capacitor for a liquid crystal display that has an increased capacitance without reducing the aperture ratio of a corresponding pixel.

Another objective of the present invention is to provide a storage capacitor for a liquid crystal display that has an increased capacitance without substantially changing conventional manufacturing processes for a liquid crystal display.

In order to achieve the above objectives, in a preferred embodiment of the present invention, a storage capacitor for a liquid crystal display is formed on a glass substrate. The storage capacitor comprises a first capacitor electrode, a first insulating layer formed on the first capacitor electrode, a second capacitor electrode formed on the first insulating layer, a second insulating layer formed on the second capacitor electrode, and a third capacitor electrode formed on the second insulating layer and electrically connected with the first capacitor electrode. In addition, the second capacitor electrode is electrically connected with the pixel electrode of the liquid crystal display.

Accordingly, the first capacitor electrode and the second capacitor electrode give rise to one capacitor, while the second capacitor electrode and the third capacitor electrode give rise to another capacitor. In sum, there are two capacitors electrically connected in parallel. The resultant equivalent capacitance of two capacitors electrically connected in parallel is equal to the sum of the capacitances of the two capacitors. Therefore, the total capacitance in this configuration is approximately doubled from that of the conventional storage capacitor without substantially changing the manufacturing process.

### BRIEF DESCRIPTION OF THE DRAWINGS

The present invention is better understood by referring to the detailed description of the preferred embodiment taken in conjunction with the drawings, in which like reference numerals denote like elements, and wherein:

FIG. 1 illustrates a pixel region of a liquid crystal display having a storage capacitor in accordance with the present invention;

FIG. 2 is a cross-sectional view taken along line II-II of FIG. 1;

FIG. 3 is a cross-sectional view taken along line III-III line of FIG. 1;

FIG. 4 illustrates a pixel region of a liquid crystal display having a conventional storage capacitor; and

FIG. 5 is a cross-sectional view taken along line V-V of FIG. 4.

### DETAILED DESCRIPTION OF THE PREFERRED EMBODIMENT

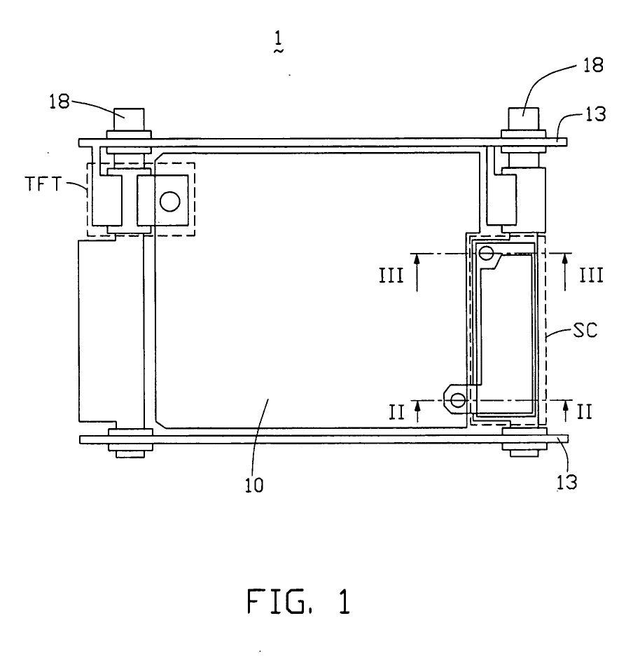

Referring to FIG. 1, a pixel region 1 of a liquid crystal display is shown, in accordance with one embodiment of the present invention. The pixel region 1 comprises a pixel electrode 10, source lines 13, gate lines 18, a thin film transistor (TFT) region and a storage capacitor (SC) region. As shown in the figure, the source lines 13 and the gate lines 18 cross each other, thus defining the pixel region 1. A portion of the pixel electrode 10 is electrically connected with the source line 18 via the thin film transistor (TFT), the thin film transistor acting as a switch for turning on and off the pixel electrode. The structure of the thin film transistor is known in the prior art. That is, a person of ordinary skill in the art can provide the TFT, and therefore a detailed description of the TFT is omitted herefrom. Another portion of the pixel electrode 10 is electrically connected with the gate line 13 via the storage capacitor (SC).

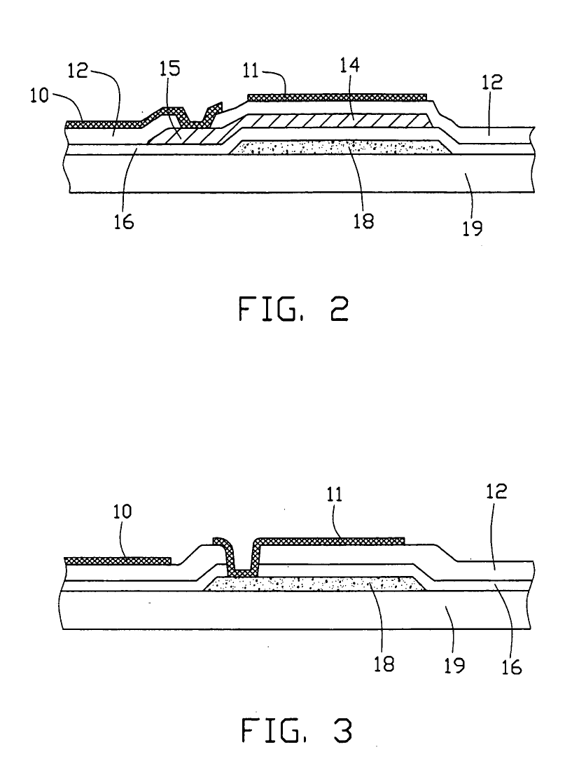

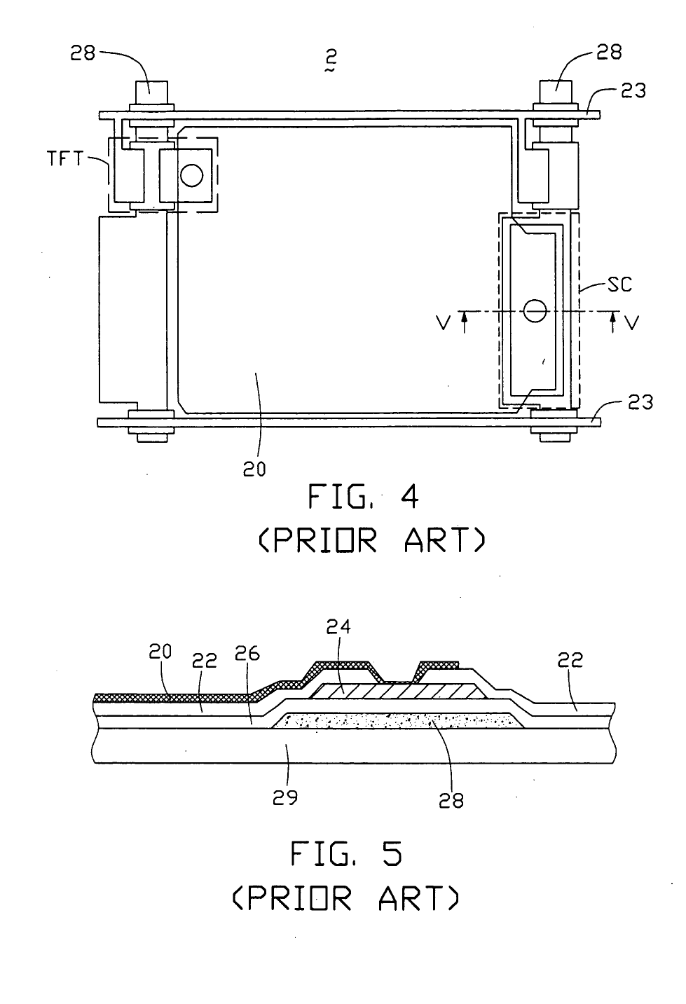

FIG. 2 and FIG. 3 are cross-sectional views of the storage capacitor taken along lines II-II and III-III of FIG. 1, respectively. The storage capacitor is formed on a glass substrate 19, and comprises a first capacitor electrode 18, a first insulating layer 16, a second capacitor electrode 14, a second insulating layer 12, and a third capacitor electrode 11. The first capacitor electrode 18 is the gate line, which may be constructed into a single-layer structure, a double-layer structure or a triple-layer structure. For a single-layer structure, the first capacitor electrode 18 is made of a conductive material such as aluminum (Al), chromium (Cr), molybdenum-tungsten (MoW), or molybdenum-niobium (MoNb). For a double-layer structure, the first capacitor electrode 18 is made of conductive materials such as molybdenum/aluminum-neodymium (Mo/AlNd), or aluminum-neodymium/chromium (AlNd/Cr). For a triple-layer structure, the first capacitor electrode 18 is made of conductive materials such as titanium/aluminum/titanium (Ti/Al/Ti) or molybdenum/aluminum/molybdenum (Mo/Al/Mo). In addition, aluminum in the above-mentioned conductive materials may be substituted into aluminum alloys such as aluminum-neodymium (AlNd), aluminum-niobium (AlNb), etc. The first insulating layer 16 is formed covering the first capacitor electrode 18 and the glass substrate 19, and is made of an insulating material such as silicon nitride (SiNx), silicon oxide, benzocyclobutene or acryl. Preferably, the first insulating layer 16 is made of silicon nitride. The second capacitor electrode 14 is formed on the first insulating layer 16 above the first capacitor electrode 18, which may be constructed into a single-layer structure, a double-layer structure or a triple-layer structure. For a single-layer structure, the second capacitor electrode 14 is made of a conductive material such as aluminum (Al), chromium (Cr), molybdenum (Mo), molybdenum-tungsten (MoW), or molybdenum-niobium (MoNb). For a double-layer structure, the second capacitor electrode 14 is made of conductive materials such as aluminum/chromium (Al/Cr) or aluminum/titanium (Al/Ti). For a triple-layer structure, the second capacitor electrode 14 is made of conductive materials such as titanium/aluminum/titanium (Ti/Al/Ti) or molybdenum/aluminum/molybdenum (Mo/Al/Mo). In addition, aluminum in the above-mentioned conductive materials may be substituted into aluminum alloys such as aluminum-neodymium (AlNd), aluminum-niobium (AlNb), etc. The second capacitor electrode 14 comprises a leg 15. The second insulating layer 12 is formed covering the second capacitor electrode 14 and the first insulating layer 16, and is made of an insulating material such as silicon nitride (SiNx), silicon oxide, benzocyclobutene or acryl. Preferably, the second insulating layer 12 is made of silicon nitride. As shown in FIG. 2, a hole is formed in the second insulating layer 12 above the leg 15 of the second capacitor electrode 14, for exposing the leg 15 of the second capacitor electrode 14. As shown in FIG. 3, a hole is formed in the second insulating layer 12 and the first insulating layer 16, for exposing the first capacitor electrode 18. Finally, as shown in FIG. 3, the third capacitor electrode 11 is formed on one portion of the second insulating layer 12, with an extending portion penetrating through the hole formed in the second insulating layer 12 and the first insulating layer 16 and electrically connecting with the first capacitor electrode 18. As shown in FIG. 2, the pixel electrode 10 is formed on another portion of the second insulating layer 12, with an extending portion penetrating through the hole formed in the second insulating layer 12 above the leg 15 of the second capacitor electrode 14, and electrically connecting with the leg 15. The third capacitor electrode 11 and the pixel electrode 10 are made of conductive materials such as indium tin oxide (ITO) or indium zinc oxide (IZO).

With this configuration, two storage capacitors are defined, one by the first capacitor electrode 18 and the second capacitor electrode 14, and the other one by the second capacitor electrode 14 and the third capacitor electrode 11. These two storage capacitors are electrically connected in parallel. Therefore, the total capacitance is significantly increased without increasing the area of the pixel electrode 10. As a result, the aperture ratio of the pixel region 1 is not limited by the presence of the advantageous storage capacitors.

While the present invention is described in detail with reference to the illustrated embodiments, it is appreciated that no limitation is intended by the above descriptions. Various equivalent modifications or alterations of the preferred embodiments described above will be apparent to those with ordinary skill in the art, and it is therefore contemplated that the present invention is defined according to the following claims in their broadest meaning. Consequently, any modifications or alterations of the preferred embodiments are considered within the scope of the present invention.

1. A storage capacitor for a liquid crystal display, comprising:
a first capacitor electrode;
a first insulating layer formed on the first capacitor electrode;
a second capacitor electrode formed on the first insulating layer;
a second insulating layer formed on the second capacitor electrode; and
a third capacitor electrode formed on the second insulating layer and electrically connected with the first capacitor electrode.

2. The storage capacitor as recited in claim 1, wherein the first capacitor electrode, constructed into a single-layer structure, comprises a conductive material selected from the group consisting of aluminum, aluminum alloy, chromium, molybdenum-tungsten, and molybdenum-niobium.

3. The storage capacitor as recited in claim 1, wherein the first capacitor electrode, constructed into a double-layer structure, comprises conductive materials selected from the group consisting of molybdenum/aluminum-neodymium, and aluminum-neodymium/chromium.

4. The storage capacitor as recited in claim 1, wherein the first capacitor electrode, constructed into a triple-layer structure, comprises conductive materials selected from the group consisting of titanium/aluminum/titanium, and molybdenum/aluminum/molybdenum.

5. The storage capacitor as recited in claim 1, wherein the first insulating layer comprises an insulating material selected from the group consisting of silicon nitride, silicon oxide, benzocyclobutene, and acryl.

6. The storage capacitor as recited in claim 1, wherein the second capacitor electrode, constructed into a single-layer structure, comprises a conductive material selected from the group consisting of aluminum, aluminum alloy, chromium, molybdenum, molybdenum-tungsten, and molybdenum-niobium.

7. The storage capacitor as recited in claim 1, wherein the second capacitor electrode, constructed into a double-layer structure, comprises conductive materials selected from the group consisting of aluminum/chromium, and aluminum/titanium.

8. The storage capacitor as recited in claim 1, wherein the second capacitor electrode, constructed into a triple-layer structure, comprises conductive materials selected from the group consisting of titanium/aluminum/titanium or molybdenum/aluminum/molybdenum.

9. The storage capacitor as recited in claim 1, wherein the second insulating layer comprises an insulating material selected from the group consisting of silicon nitride, silicon oxide, benzocyclobutene, and acryl.

10. The storage capacitor as recited in claim 1, wherein the third capacitor electrode comprises a conductive material selected from the group consisting of indium tin oxide and indium zinc oxide.

11 .A storage capacitor in a liquid crystal display, comprising:
a first capacitor electrode;
a first insulating layer formed on the gate line;
a second capacitor electrode formed on the first insulating layer;
a second insulating layer formed on the second capacitor electrode; and
a third capacitor electrode formed on the second insulating layer, having a protruding portion for electrically connecting with the first capacitor electrode.

12. The storage capacitor as recited in claim 11, wherein the protruding portion of the third capacitor electrode penetrates through the second insulating layer and the first insulating layer, and electrically connects with the first capacitor electrode.

13. The storage capacitor as recited in claim 11, wherein the first capacitor electrode, constructed into a single-layer structure, comprises a conductive material selected from the group consisting of aluminum, aluminum alloy, chromium, molybdenum-tungsten, and molybdenum-niobium.

14. The storage capacitor as recited in claim 11, wherein the first capacitor electrode, constructed into a double-layer structure, comprises conductive materials selected from the group consisting of molybdenum/aluminum-neodymium, and aluminum-neodymium/chromium.

15. The storage capacitor as recited in claim 11, wherein the first capacitor electrode, constructed into a triple-layer structure, comprises conductive materials selected from the group consisting of titanium/aluminum/titanium, and molybdenum/aluminum/molybdenum.

16. The storage capacitor as recited in claim 11, wherein the first insulating layer comprises an insulating material selected from the group consisting of silicon nitride, silicon oxide, benzocyclobutene, and acryl.

17. The storage capacitor as recited in claim 11, wherein the second capacitor electrode, constructed into a single-layer structure, comprises a conductive material selected from the group consisting of chromium, molybdenum, molybdenum-tungsten, and molybdenum-niobium.

18. The storage capacitor as recited in claim 11, wherein the second capacitor electrode, constructed into a double-layer structure, comprises conductive materials selected from the group consisting of aluminum/chromium, and aluminum/titanium.

19. The storage capacitor as recited in claim 11, wherein the second capacitor electrode, constructed into a triple-layer structure, comprises conductive materials selected from the group consisting of titanium/aluminum/titanium or molybdenum/aluminum/molybdenum.

20. The storage capacitor as recited in claim 11, wherein the second insulating layer comprises an insulating material selected from the group consisting of silicon nitride, silicon oxide, benzocyclobutene, and acryl.

21. The storage capacitor as recited in claim 11, wherein the third capacitor electrode comprises a conductive material selected from the group consisting of indium tin oxide and indium zinc oxide.

22. A storage capacitor for a liquid crystal display, comprising:
a first capacitor electrode;
a first insulating layer formed on the first capacitor electrode;
a second capacitor electrode formed on the first insulating layer;
a second insulating layer formed on the second capacitor electrode; and
a third capacitor electrode formed on the second insulating layer with a portion being offset from the second capacitor and extending toward and engaged with the first capacitor electrode.
